(19) United States
(12) Patent Application Publication
(10) Pub. No.: US 2004/0109124 A1
(43) Pub. Date: Jun. 10, 2004

(54) Substrate bonding apparatus and liquid crystal display panel

(75) Inventor: Hirokazu Masuda, Yokohama-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shibaura Mechatronics Corporation, Yokohama-shi (JP)

(21) Appl. No.: 10/726,401

(22) Filed: Dec. 3, 2003

(30) Foreign Application Priority Data
Dec. 4, 2002 (JP) 2002-352709
Oct. 23, 2003 (JP) 2003-363339

(51) Int. Cl. G02F 1/1339

(52) U.S. Cl. 349/153

(57) ABSTRACT

A bonding apparatus which bonds two substrates together with a sealing agent applied to, in the form of a frame, on one of the substrates. The apparatus comprises a first retaining table having a retaining surface which retains a first substrate thereon, a second retaining table opposed to the first retaining table and having a retaining surface which retains a second substrate thereon, a nonviscous elastic material provided on that part of the retaining surface of at least one of the retaining tables which retains the substrate thereon, and first and second drive sources which relatively drive the first and second retaining tables in the vertical direction so that the substrates on the respective retaining surfaces of the retaining tables are bonded together with the sealing agent.

### CROSS-REFERENCE TO RELATED APPLICATIONS

This application is based upon and claims the benefit of priority from the prior Japanese Patent Applications No. 2002-352709, filed Dec. 4, 2002; and No. 2003-363339, filed Oct. 23, 2003, the entire contents of both of which are incorporated herein by reference.

### BACKGROUND OF THE INVENTION

1. Field of the Invention

The present invention relates to a bonding apparatus for bonding two substrates together with a sealing agent and a liquid crystal display panel manufactured by means of the bonding apparatus.

2. Description of the Related Art

In manufacturing processes for flat display panels that are represented by a liquid crystal display panel, two substrates are opposed to each other across a given space, a liquid crystal as a fluid is sealed in the space between the substrates, and the substrates are bonded together with a sealing agent for use as an adhesive agent.

In this bonding operation, the sealing agent is applied to, in the form of a frame, on one of the two substrates, and the liquid crystal is dripped in a given quantity on that part of either substrate which corresponds to the frame of the sealing agent.

Then, the two substrates are held on the respective retaining surfaces of upper and lower retaining tables in a chamber and brought close to each other. Subsequently, the lower substrate is driven in X- and Y-directions, which extend at right angles to each other in the horizontal direction, and in a θ-direction around an axis perpendicular to the X- and Y-directions. By doing this, the substrates are aligned with each other. Thereafter, the upper substrate is lowered and subjected to a given pressure, whereupon the substrates are bonded together with the sealing agent.

Unless the parallelism between the respective retaining surfaces of the upper and lower retaining tables that retain the substrates thereon is maintained with high accuracy, in pressuring and bonding the two substrates, the sealing agent cannot be uniformly flattened, so that the substrates undulate. In consequence, the two substrates fail to be bonded with high accuracy.

Even if the parallelism between the retaining surfaces that retain the substrates thereon is maintained, the thickness of the substrates sometimes may be subject to variation. In this case, the pressure that acts on the substrates may vary, so that the sealing agent may possibly fail to be flattened uniformly.

Modern substrates, in particular, tend to be large, so that the retaining surfaces of the retaining tables are also large. Thus, in order to pressurize the substrates evenly as they are bonded together, the large retaining surfaces of the retaining tables must be machined with the accuracy of μm-order, which is very hard, however.

Conventionally, therefore, the retaining surfaces that retain the substrates thereon are formed of a soft elastic material, such as a soft polyvinyl chloride sheet, silicone rubber, rubber plate, etc., as is described in Jpn. UM Appln. KOKAI Publication No. 5-36426.

If the retaining tables are subject to surface irregularities, or if the thickness of the substrates is subject to variation, the soft elastic material of the retaining surfaces are elastically deformed to absorb the irregularities or variation as the substrates are bonded. Thus, the sealing agent can be uniformly flattened to bond the two substrates together.

If the retaining surfaces are merely formed of a soft elastic material, however, the substrates may possibly be attracted to the surface of the elastic material that forms the retaining surfaces by means of the force of adhesion of the material surface when the pressure is applied to the substrates to be bonded.

When the bonded substrates are raised to be carried away from the retaining surfaces, therefore, they are bent considerably or locally by means of the force of adhesion of the elastic material that forms the retaining surfaces. Thus, the bonded substrates may undergo dislocation.

The object of the present invention is to provide a substrate bonding apparatus, of which the bonding accuracy for two substrates can be prevented from being lowered by an elastic material for retaining surfaces that retain the substrates thereon, and a liquid crystal display panel manufactured by means of the bonding apparatus.

### BRIEF SUMMARY OF THE INVENTION

According to an aspect of the present invention, there is provided a substrate bonding apparatus which bonds two substrates together with a sealing agent applied to, in the form of a frame, on one of the substrates, comprising: a first retaining table having a retaining surface which retains one substrate thereon; a second retaining table opposed to the first retaining table and having a retaining surface which retains the other substrate thereon; a nonviscous elastic material provided on that part of the retaining surface of at least one of the retaining tables which retains the substrate thereon; and drive means which relatively drives the first and second retaining tables in the vertical direction so that the substrates on the respective retaining surfaces of the retaining tables are bonded together with the sealing agent.

According to another aspect of the invention, there is provided a substrate bonding apparatus which bonds two substrates together with a sealing agent applied to, in the form of a frame, on one of the substrates, comprising: a first retaining table having a retaining surface which retains one substrate thereon; a second retaining table opposed to the first retaining table and having a retaining surface which retains the other substrate thereon; an elastic material divided into a plurality of elastic pieces provided on that part of the retaining surface of at least one of the retaining tables which retains the substrate thereon; and drive means which relatively drives the first and second retaining tables in the vertical direction so that the substrates on the respective retaining surfaces of the retaining tables are bonded together with the sealing agent.

According to a further aspect of the invention, there is provided a substrate bonding apparatus which bonds two substrates together with a sealing agent applied to, in the form of a frame, on one of the substrates, comprising: a first retaining table having a retaining surface which retains one substrate thereon; a second retaining table opposed to the first retaining table and having a retaining surface which retains the other substrate thereon; an elastic material having an A-scale Shore hardness of 40 to 90 and provided on that part of the retaining surface of at least one of the retaining tables which retains the substrate thereon; and drive means which relatively drives the first and second retaining tables in the vertical direction so that the substrates on the respective retaining surfaces of the retaining tables are bonded together with the sealing agent.

According to an additional aspect of the invention, there is provided a liquid crystal display panel which has two substrates bonded together with a sealing agent applied to, in the form of a frame, on one of the substrates, the substrates being bonded by means of a bonding apparatus which comprises: a first retaining table having a retaining surface which retains one substrate thereon; a second retaining table opposed to the first retaining table and having a retaining surface which retains the other substrate thereon; a nonviscous elastic material provided on that part of the retaining surface of at least one of the retaining tables which retains the substrate thereon; and drive means which relatively drives the first and second retaining tables in the vertical direction so that the substrates on the respective retaining surfaces of the retaining tables are bonded together with the sealing agent.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is schematic view of a bonding apparatus according to a first embodiment of the invention;

FIGS. 2A, 2B and 2C are is plan views of a first retaining table according to a second embodiment of the invention;

FIG. 3 is a plan view of a first retaining table according to a third embodiment of the invention;

FIG. 4 is a sectional view taken along line IV-IV of FIG. 3;

FIG. 5 is a side view of a pedestal having elastic pieces; and

FIG. 6 is a plan view of the pedestal shown in FIG. 5.

### DETAILED DESCRIPTION OF THE INVENTION

A first embodiment of the present invention will now be described with reference to the accompanying drawings.

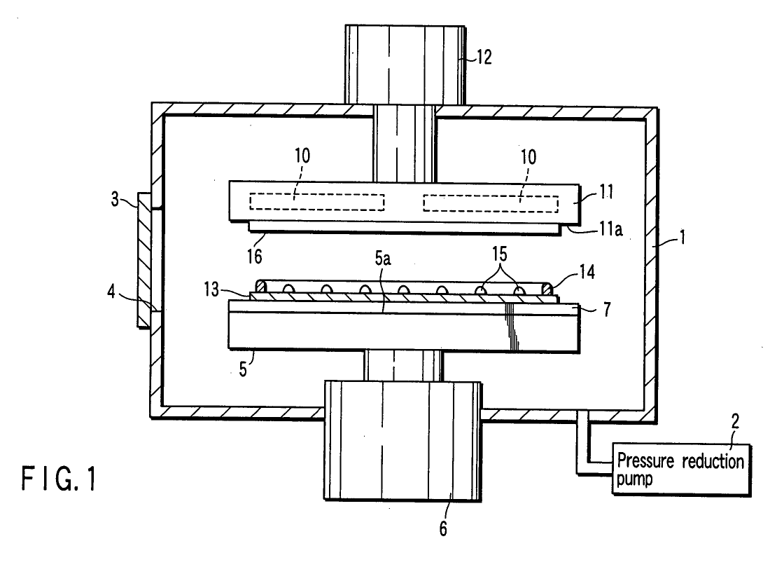

FIG. 1 shows a substrate bonding apparatus according to the first embodiment of the invention. The bonding apparatus comprises a chamber 1. The interior of the chamber 1 can be decompressed to a give pressure of, e.g., about 1 Pa by a pressure reduction pump 2. A gate 4 is formed on one side of the chamber 1. It is closed airtightly by means of a shutter 3.

A first retaining table 5 is located in the chamber 1. It is driven by means of a first drive source 6 in X- and Y-directions, which extend at right angles to each other in the horizontal direction, and in a θ-direction around an axis that extends at right angles to the XY plane.

The upper surface of the first retaining table 5 forms a retaining surface 5a, and an elastic sheet 7 is put on the surface 5a. The elastic sheet 7 is formed of fluororubber, for example.

The elastic sheet 7 has a size large enough to cover the whole upper surface of the first retaining table 5. One surface of the sheet 7 is fixed to the retaining surface 5a of the table 5 by adhesive bonding, and at least the other surface is irradiated with charged particles for surface treatment, whereby it is reformed into a nonviscous surface. Thus, the charged particles are applied to the elastic sheet 7 so that the state of the chemical bond of its surface is changed. Even if a glass substrate for a liquid crystal display panel is put on the sheet surface in the manner mentioned later, therefore, the nonviscous surface has no force of adhesion to the substrate.

Further, the one surface of the elastic sheet 7, as well as the other surface, may be irradiated with the charged particles so that both surfaces are reformed to be nonviscous. If both surfaces of the elastic sheet 7 are nonviscous, the surface to be adhesively bonded need not be selected, and therefore, cannot be mistaken when the sheet 7 is bonded to the retaining surface 5a of the first retaining table 5.

The hardness of the elastic sheet 7 can be freely set by changing the composition of the rubber material. The elastic material used in this embodiment has an A-scale Shore hardness in the range of 40 to 90.

In the chamber 1, a second retaining table 11 overlies the first retaining table 5. The second retaining table 11 can be driven by means of a second drive source 12 in a Z-direction or vertical direction in which it moves toward and away from the first retaining table 5. The second retaining table 11 is provided with electrodes 10 that generate an electrostatic force. When a DC voltage from a DC power source (not shown) is applied to the electrodes 10, the substrate can be electrostatically attracted to and held on a retaining surface 11a of the second retaining table 11.

The first retaining table 5 may be made to be able to be driven in the Z-direction, and in this case, the second retaining table 11 is allowed to be driven in the X-, Y-, and θ-directions. Alternatively, either of the retaining tables may be made to be movable in the X-, Y-, Z-, and θ-directions.

A first substrate 13, one of a pair of glass substrates that constitute the liquid crystal display panel, is fed onto the elastic sheet 7 on the first retaining table 5 through the gate 4. A sealing agent 14 is applied to, in the form of a rectangular frame, on the upper surface of the first substrate 13, and a liquid crystal 15 in the form of liquid drops is fed into the frame.

The retaining surface 11a of the second retaining table 11 is fed with a second substrate 16, the other substrate. The second substrate 16 is attracted to and held on the retaining surface 11a by means of the electrostatic force that is generated thereon. The first substrate 13 and the second substrate 16 are bonded together with the sealing agent 14 after they are horizontally aligned with each other.

The following is a description of operation for bonding the first and second substrates 13 and 16 together by means of the bonding apparatus constructed in this manner. The first substrate 13 is fed onto the elastic sheet 7 on the retaining surface 5a of the first retaining table 5, and the second substrate 16 is supplied to the retaining surface 11a of the second retaining table 11 and held by electrostatic force. Thereafter, the gate 4 is closed, and a pressure reduction pump 2 is actuated to decompress the interior of the chamber 1.

When the chamber 1 is decompressed inside, the second retaining table 11 is lowered so that the second substrate 16 on the table 11 is brought close to the first substrate 13 that is placed on the retaining surface 5a of the elastic sheet 7 of the first retaining table 5. In this state, images of positioning marks (not shown) that are formed on the substrates 13 and 16 are picked up by means of a image-pickup camera (not shown), and alignment operation is carried out. In the alignment operation, the first substrate 13 is driven in the X- and Y-directions so that the positioning marks are aligned.

After the alignment operation, the marks are checked for dislocation. If the dislocation exceeds its tolerance, the alignment operation is carried out again. After the alignment, the second substrate 16 is lowered, and a given pressure is applied to the first and second substrates 13 and 16. Thereupon, the substrates 13 and 16 are bonded together.

After the bonding operation is finished, the electrostatic force is removed from the second retaining table 11, and the table 11 is raised. At the same time, the bonded substrates 13 and 16 are lifted from the upper surface of the elastic sheet 7 of the first retaining table 5 by means of a lift pin (not shown) or the like. Thereafter, the substrates 13 and 16 are carried out of the chamber 1.

At least the upper surface of the elastic sheet 7 onto which the first substrate 13 is fed is reformed into a nonviscous surface. If the first and second substrates 13 and 16 are pressurized by the second retaining table 11 as they are bonded together, therefore, the first substrate 13 can be prevented from being attracted to the upper surface of the elastic sheet 7.

Thus, when the bonded first and second substrates 13 and 16 are carried away from the first retaining table 5, they can be separated and raised from the upper surface of the elastic sheet 7 without being deformed by the sheet 7. Accordingly, dislocation between the bonded substrates 13 and 16 that lowers the positioning accuracy can be prevented.

An A-scale Shore hardness of the elastic sheet 7 is adjusted to 40 to 90. It was experimentally confirmed that the paired substrates 13 and 16 were able to be positioned and bonded more accurately with use of the elastic sheet 7 having an A-scale Shore hardness of 40 to 90 than with use of elastic sheets having hardness outside the range.

TABLE 1 shows experimentally confirmed influences of slippage of the substrates on the elastic sheet and elastic deformation of the sheet upon the positioning of the substrates. Six types of elastic sheets having an A-scale Shore hardness of 30 to 100 were used in this experiment.

TABLE 1

| A-Scale | | | | | | |
|---|---|---|---|---|---|---|
| Shore Hardness | 30 | 40 | 60 | 70 | 90 | 100 |
| Influences | ◯ | ◯ | ◯ | ◯ | Δ | X |
| of slippage | | | | | | |
| Influences | X | Δ | ◯ | ◯ | ◯ | ◯ |
| of elastic | | | | | | |
| deformation | | | | | | |

In TABLE 1, ◯ indicates that the substrates were able to be smoothly positioned with accuracy, while Δ indicates that the substrates were able to be accurately positioned after repeated alignment operation. On the other hand, X indicates that satisfactory positioning accuracy was not able to be obtained even after repeated alignment operation.

The substrates were aligned with use of the elastic sheets having the Shore hardness shown in TABLE 1, and the influences of slippage of the substrates upon the positioning accuracy were examined. When the A-scale Shore hardness was not higher than 70, the substrates hardly slipped on the elastic sheet. When the A-scale Shore hardness was 90, the substrates were able to be positioned with a given accuracy by repeating the alignment operation, although they somewhat slipped. When the A-scale Shore hardness was 100, the substrates slipped so much on the elastic sheet that the given positioning accuracy was not able to be obtained despite repeated alignment operation.

The influences of elastic deformation of the elastic sheet upon the positioning accuracy were also examined. When the A-scale Shore hardness was not lower than 60, the elastic deformation never lowered the positioning accuracy. When the A-scale Shore hardness was 40, the given positioning accuracy was able to be obtained by repeating the alignment operation, although elastic deformation to lower the positioning accuracy was caused. When the A-scale Shore hardness of the elastic sheet was 30, the deformation increased so much during the positioning operation that the given positioning accuracy was not able to be obtained despite repeated alignment operation.

Accordingly, the A-scale Shore hardness of the elastic sheet 7 on the retaining surface 5a of the first retaining table 5 is adjusted to 40 to 90. By doing this, the first and second substrates 13 and 16 can be bonded together without lowering the positioning accuracy despite the use of the elastic sheet 7 for the first retaining table 5 that retains the first substrate 13 thereon.

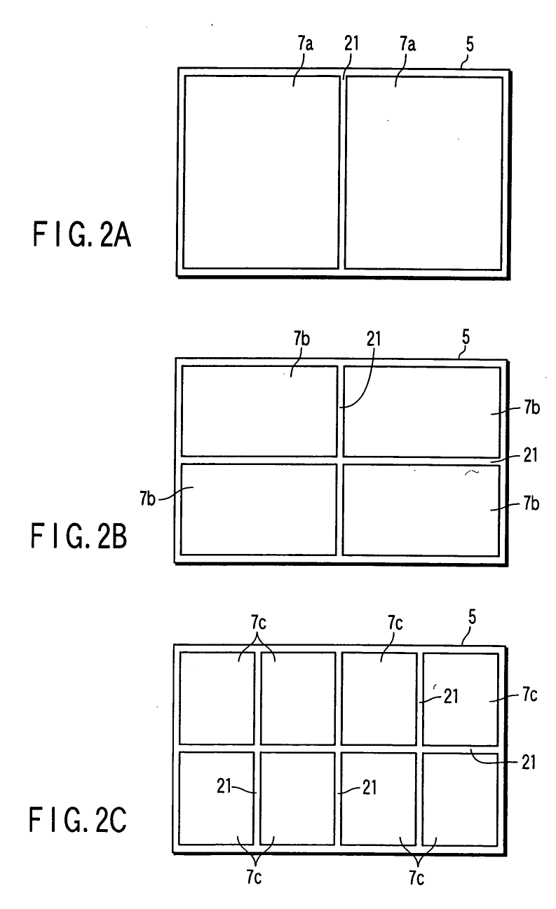

FIGS. 2A, 2B and 2C show a second embodiment of the present invention. In this embodiment, an elastic material on a first retaining table 5 is divided into a plurality of pieces. In FIG. 2A, an elastic sheet 7 is divided into two elastic pieces 7a that are half as large as the first retaining table 5 each. These elastic pieces 7a are attached to the first retaining table 5 with a given gap 21 between them.

In FIG. 2B, an elastic sheet 7 is divided into four elastic pieces 7b, which are arranged with given gaps 21 between them. In FIG. 2C, an elastic sheet 7 is divided into eight elastic pieces 7c, which are arranged with given gaps 21 between them.

Even if one of the elastic pieces 7a, 7b or 7c of the elastic sheet 7 is elastically deformed, the other elastic pieces can be protected against propagation of the elastic deformation. Thus, the local elastic deformation of the elastic sheet 7 can be prevented from considerably influencing the positioning accuracy of the first and second substrates 13 and 16. Since the first substrate 13 can be securely held by means of the other elastic pieces if one elastic piece undergoes substantial elastic deformation, it can be prevented from slipping on the elastic pieces.

The elastic sheet 7 is divided into the elastic pieces 7a, 7b or 7c, and the gap or gaps 21 are formed between them. In this arrangement, some of dust that collects on the first retaining table 5 gets into the gap(s) 21. Thus, the probability of interposition of dust between the elastic sheet 7 and the first substrate 13 thereon can be lowered. This also improves the bonding accuracy.

If the elastic sheet 7 is divided into the elastic pieces 7a, 7b or 7c, moreover, the area of contact between the sheet 7 and the first substrate 13 can be made narrower than in the case where the elastic sheet 7 is one piece that covers the whole upper surface of the first retaining table 5. Thus, the force of adhesion of the elastic pieces 7a, 7b or 7c to attract the first substrate 13 can be reduced. In consequence, the bonded substrates 13 and 16 can be restrained from bending as they are carried away from the first retaining table 5, so that their positioning accuracy can be prevented from being lowered.

In the second embodiment, at least those surfaces of the elastic pieces 7a, 7b and 7c which retain the first substrate 13 thereon may be reformed into nonviscous surfaces by irradiation with charged particles. Further, an A-scale Shore hardness of the elastic pieces 7a, 7b and 7c of the elastic sheet 7 may be adjusted to 40 to 90. Furthermore, the surfaces of the divided elastic pieces 7a, 7b and 7c may be reformed into nonviscous surfaces, and the elastic pieces 7a, 7b and 7c an A-scale Shore hardness of 40 to 90. By doing this, the same functions and effects as in the first embodiment can be obtained. The elastic material may be divided into any number of elastic pieces greater than one.

Each elastic piece need not always be rectangular in shape, and may alternatively be of a circular or any other shape. According to the present invention, dividing the elastic sheet includes forming grooves of a given depth in the sheet so that the sheet is divided by the grooves.

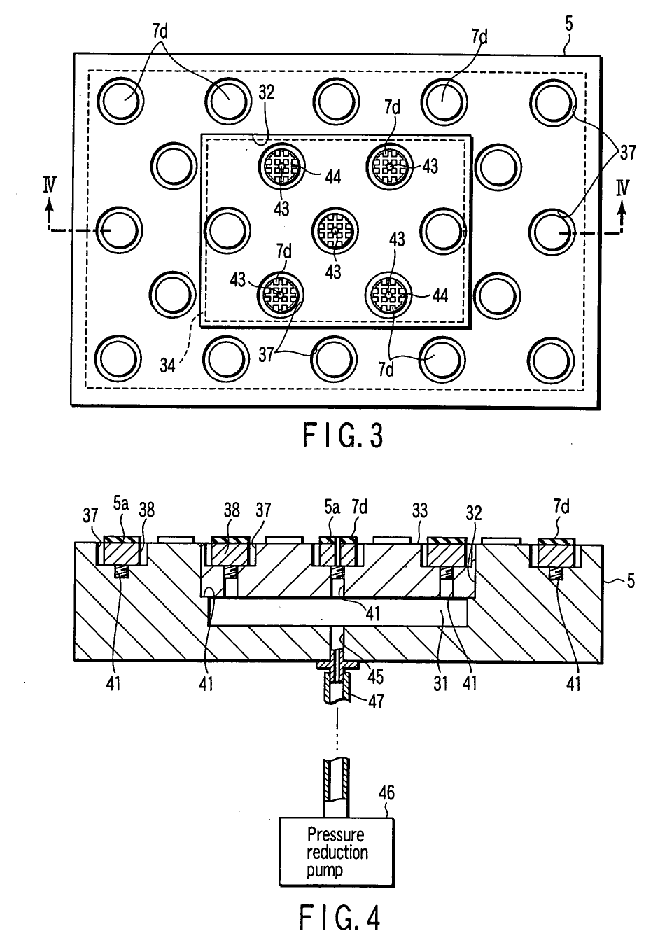

FIGS. 3 to 6 show a third embodiment of the present invention. This embodiment involves a modification of the first retaining table 5 of the first embodiment. More specifically, a chamber 31 is formed in the central portion of the first retaining table 5 so as to be located halfway in the thickness direction. The chamber 31 forms a rectangular first recess 32 that opens in that surface of the first retaining table 5 which is fed with the first substrate 13. A closing plate 33 closes the opening portion of the first recess 32.

A step portion 34 is formed on the middle part of the inner peripheral surface of the first recess 32 with respect to the height direction. The closing plate 33 is airtightly fitted in the recess 32 with its peripheral edge portion in engagement with the step portion 34.

A plurality of circular second recesses 37 are made in a staggered pattern in that surface of the first retaining table 5 which includes one side face of the closing plate 33. A columnar pedestal 38 is located in each second recess 37. The pedestal 38 has an external thread 39 on its one end face. A disc-shaped elastic piece 7d for use as an elastic material is fixed to the other end face of the pedestal 38 by adhesive bonding. Thus, according to this embodiment, the other end face of each pedestal 38 forms a retaining surface 5a that is provided with the elastic piece 7d. The first substrate 13 can be retained on the retaining surface 5a by means of the elastic piece 7d in the manner mentioned later.

Like the elastic pieces of the first and second embodiments, the elastic piece 7d may be formed of a material that fulfills the requirement that supports, at its top, the first substrate 13 is nonviscous and/or has an A-scale Shore hardness of 40 to 90.

A tapped hole 41 is formed in the bottom of each second recess 37. The pedestal 38 is removably attached to the second recess 37 with its external thread 39 screwed in the tapped hole 41. The upper end face of the elastic piece 7d on the pedestal 38 is horizontal when the external thread 39 is screwed in the tapped hole 41 so that the pedestal 38 is fixed in the second recess 37. As shown in FIG. 4, the elastic piece 7d slightly projects upward from the opening of the second recess 37.

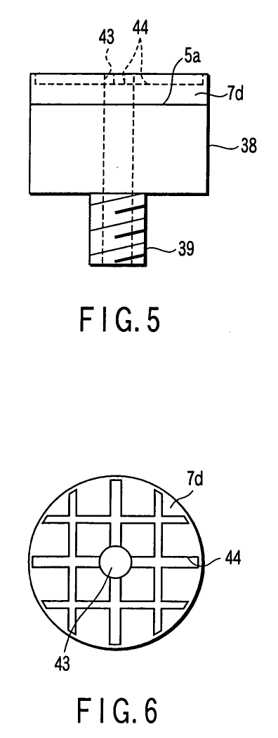

In this embodiment, seven second recesses 37 are formed in the closing plate 33. The respective tapped holes 41 of the second recesses 37 penetrate the closing plate 33 in its thickness direction and form second communication holes. Those pedestals 38 which are attached to the five second recesses 37 other than the two second recesses 37 that are situated at the longitudinally opposite end portions of the closing plate 33 are formed having a first communication hole 43 each. As shown in FIGS. 5 and 6, each hole 43 extends from the end face of the external thread 39, penetrates the retaining surface 5a that carries the elastic piece 7d thereon, and opens in the upper end face of the piece 7d. Thus, the chamber 31 communicates with the first communication hole 43 of the elastic piece 7d by means of the tapped hole 41.

The two second recesses 37 that are situated at the longitudinally opposite end portions of the closing plate 33 are fitted individually with the pedestals 38 to which the elastic pieces 7d without the first communication hole 43 are fixed by adhesive bonding. Accordingly, the tapped holes 41 as the second communication holes that are formed individually in those two second recesses 37 are closed by the pedestals 38.

Thus, when the pedestals 38 having the first communication holes 43 that individually open in the respective upper end faces of the elastic pieces 7d are attached, the tapped holes 41 of the seven second recesses 37 in the closing plate 33 internally connect the holes 43 and the chamber 31. The tapped holes 41 are closed when the pedestals 38 to which the elastic pieces 7d without the first communication hole 43 are attached.

As shown in FIG. 6, latticed grooves 44 are formed in the upper end face of the elastic piece 7d that is attached to each pedestal 38.

Although the elastic piece 7d shown in FIG. 6 is provided with the first communication hole 43, the grooves 44 are also formed in each of the other elastic pieces 7d without the first communication hole 43. The grooves 44 are formed, with no ends opening at the outer circumferential surface of the elastic piece 7d. Thus, when the first substrate 13 is brought intimately into contact with the elastic piece 7d, the grooves 44 are closed without internally connecting with the chamber 1.

Although the grooves 44 are formed in all the elastic pieces 7d according to this embodiment, they may alternatively be formed in selected ones of the elastic pieces 7d only.

A connecting hole 45 is formed in the first retaining table 5. One end of the hole 45 communicates with the chamber 31, and the other end opens in that surface of the table 5 opposite from the second recesses 37. A pressure reduction pump 46 for use as decompression means is connected to the other end of the connecting hole 45 by means of a pipe 47 that is provided with an on-off valve (not shown).

If the on-off valve is opened, according to this configuration, the sucking force of the pressure reduction pump 46 acts on the respective first communication holes 43 of the elastic pieces 7d of the five other pedestals 38, out of the seven pedestals 38 that are attached to the closing plate 33. If the sucking force is applied to the first communication holes 43 as the first substrate 13 is supplied to the first retaining table 5, therefore, the substrate 13 is attracted to and held on the elastic pieces 7d by means of the sucking force. Thus, the first substrate 13 can be prevented from slipping as it is fed onto the table 5.

The sucking force that acts on the first communication holes 43 should only be applied when the first substrate 13 is fed onto the first retaining table 5. Therefore, the on-off valve must only be opened when the substrate 13 engages the upper surface of the table 5 and closed when placing the substrate 13 on the table 5 is finished. Alternatively, however, the second substrate 16 may be bonded to the first substrate 13 so that the opening operation can be continued until the point of time immediately before the substrates are carried out of the chamber 1.

Further, the grooves 44 that are formed in the elastic pieces 7d serve to reduce the area of contact between the first substrate 13 and the pieces 7d. Therefore, the bonded first and second substrates 13 and 16 can be easily removed from the first retaining table 5 without bending.

Thus, dislocation between the bonded first and second substrates 13 and 16 can be prevented more securely.

The present invention is not limited to the embodiments described above. For example, the elastic material or sheet may be provided on each of the two retaining tables or on the second retaining table only, instead of being located on the first retaining table only.

In the foregoing embodiments, the first and second substrates are bonded together in a decompressed atmosphere. However, the present invention is also applicable to the case where the substrates are bonded in the open air. In this case, the liquid crystal should only be injected between the first and second substrates after the substrates are bonded together.

Although the sealing agent and the liquid crystal are provided on the first substrate in the foregoing embodiments, they may be provided on either of the substrates. Alternatively, the sealing agent may be provided on one substrate, and the liquid crystal on the other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A substrate bonding apparatus which bonds two substrates together with a sealing agent applied to and spread in the form of a frame on one of the substrates, comprising:
a first retaining table having a retaining surface which retains one substrate thereon;
a second retaining table opposed to the first retaining table and having a retaining surface which retains the other substrate thereon;
a nonviscous elastic material provided on that part of the retaining surface of at least one of the retaining tables which retains the substrate thereon; and
drive means which relatively drives the first and second retaining tables in the vertical direction so that the substrates on the respective retaining surfaces of the retaining tables are bonded together with the sealing agent.

2. A substrate bonding apparatus according to claim 1, wherein the elastic material is divided into a plurality of elastic pieces.

3. A substrate bonding apparatus according to claim 1, wherein the elastic material has an A-scale Shore hardness of 40 to 90.

4. A substrate bonding apparatus according to claim 1, wherein the elastic material is divided into a plurality of elastic pieces and has an A-scale Shore hardness of 40 to 90.

5. A substrate bonding apparatus which bonds two substrates together with a sealing agent applied to and spread in the form of a frame on one of the substrates, comprising:
a first retaining table having a retaining surface which retains one substrate thereon;
a second retaining table opposed to the first retaining table and having a retaining surface which retains the other substrate thereon;
an elastic material divided into a plurality of elastic pieces provided on that part of the retaining surface of at least one of the retaining tables which retains the substrate thereon; and
drive means which relatively drives the first and second retaining tables in the vertical direction so that the substrates on the respective retaining surfaces of the retaining tables are bonded together with the sealing agent.

6. A substrate bonding apparatus according to claim 5, wherein at least some of the elastic pieces on the retaining table are formed having a first communication hole each, the first communication hole being connected with decompression means such that the substrate can be attracted to and held on the elastic pieces by means of a sucking force generated in the first communication hole by the decompression means.

7. A substrate bonding apparatus according to claim 6, wherein the elastic pieces are removably provided on the retaining table, the retaining table having second communication holes which individually open in those portions thereof to which the elastic pieces with the first communication hole are attached, the first communication hole is connected to the decompression means through the corresponding second communication hole in a manner such that the elastic pieces with the first communication hole are attached to the retaining table, and the second communication hole is closed when the elastic pieces without the first communication hole are attached to those portions of the retaining table in which the second communication holes open.

8. A substrate bonding apparatus according to claim 5, wherein the elastic material has an A-scale Shore hardness of 40 to 90.

9. A substrate bonding apparatus which bonds two substrates together with a sealing agent applied to, in the form of a frame, on one of the substrates, comprising:
a first retaining table having a retaining surface which retains one substrate thereon;
a second retaining table opposed to the first retaining table and having a retaining surface which retains the other substrate thereon;
an elastic material having an A-scale Shore hardness of 40 to 90 and provided on that part of the retaining surface of at least one of the retaining tables which retains the substrate thereon; and
drive means which relatively drives the first and second retaining tables in the vertical direction so that the substrates on the respective retaining surfaces of the retaining tables are bonded together with the sealing agent.

10. A liquid crystal display panel which has two substrates bonded together with a sealing agent applied to, in the form of a frame, on one of the substrates, the substrates being bonded by means of a bonding apparatus which comprises:
a first retaining table having a retaining surface which retains one substrate thereon;
a second retaining table opposed to the first retaining table and having a retaining surface which retains the other substrate thereon;
a nonviscous elastic material provided on that part of the retaining surface of at least one of the retaining tables which retains the substrate thereon; and
drive means which relatively drives the first and second retaining tables in the vertical direction so that the substrates on the respective retaining surfaces of the retaining tables are bonded together with the sealing agent.
